(19) United States
(12) Patent Application Publication
(10) Pub. No.: US 2002/0095280 A1
(43) Pub. Date: Jul. 18, 2002

(54) Programmable memory emulator capable of emulating unspecified memory devices

(75) Inventors: Shing-Wu Tung, Taipei (TW); Tsai-Min Chiang, Junghe City (TW); Wei-Jou Chen, Hsinchu (TW); Wu-Han Yang, Kaohsiung (TW); Jia-En Chuang, Tainan (TW)

Correspondence Address: BACON & THOMAS, PLLC, 625 SLATERS LANE, FOURTH FLOOR, ALEXANDRIA, VA, 22314

(73) Assignee: Industrial Technology Research Institute, Hsinchu (TW)

(21) Appl. No.: 09/907,739

(22) Filed: Jul. 19, 2001

(30) Foreign Application Priority Data
Jan. 16, 2001 (TW) 090100976

(51) Int. Cl. G06F 9/455

(52) U.S. Cl. 703/24

(57) ABSTRACT

There is disclosed a programmable memory emulator capable of emulating unspecified memory devices. A smart I/O interface is provided in the emulator for being programmed to conform to the interface specifications of different memory devices. An emulation look-ahead memory is employed to replace conventional two-port RAM. Furthermore, the memory of a host is utilized to emulate the functionality of system memory. Thus, the memory emulator is able to emulate various kinds of memory device, and the memory space is only restricted by the host.

### BACKGROUND OF THE INVENTION

1. Field of the Invention

The present invention relates to the field of memory emulation and, more particularly, to a programmable memory emulator capable of emulating unspecified memory devices.

2. Description of Related Art

Conventionally, a memory emulator such as read only memory (ROM) emulator is employed in developing programs for embedded microprocessor in which a two-port random access memory (RAM) is utilized to implement the function of the non-volatile memory, such as ROM, EPROM, EEPROM, Flash memory, etc., so as to speed up the system debugging and program development. For example, in FIG. 10, an application incorporated a conventional memory emulator is illustrated, wherein the non-volatile memory program codes and corresponding data structure are prepared by the host 91, and then are downloaded to the two-port RAM 93 in the memory emulator 92 through a transmission line. Thus, by switching the I/O signals of the two-port RAM 93, it is applicable to achieve the object of emulating the non-volatile memory 95 in the target system 94.

In implementing the function of the ROM/RAM emulator, the host 91 can read and/or write RAM 93 in the memory emulator 92. The memory emulator 92 can fully take advantage of the features of various memory devices for increasing the efficiency of designing a microprocessor based system. However, such a memory emulator suffers from several disadvantages. For example, it is only adapted to a specific memory device having a predetermined pin configuration. Further, it is incapable of directly emulating memory devices packaged in different manners. This memory emulator is usually employed in emulating specified memory devices such as EPROM 27xx, PROM 28xx, DRAM 41xx, etc. If it is desired to emulate the memory devices with different packages, an adapter is required to transform the pin configuration. The specification of memory to be employed must be determined in the beginning of designing an embedded microprocessor based system. This may significantly decrease the selection flexibility of devices of the system.

It is known that the size of a memory device to be emulated by a memory emulator is limited by the specifications of the selected memory device. Thus, a programmer of an embedded microprocessor based system must pay great attention to the occupied space of the program which is not allowed to exceed the allowable emulation space in the developing process. Thus, many limitations may be placed on the conventional two-port RAM based memory emulator in the SOC design application due to the limited memory and the specific interface specifications. As a result, the flexibility of adjusting system parameters (e.g., synchronous or asynchronous interfaces, memory size, etc.) by SOC based on a specific application can not be fully utilized.

U.S. Pat. No. 5,371,878 granted to Robert T. Coker disclosed a system for analysis of embedded computer systems, wherein buffers are provided for solving the problem of unequal processing speeds between the memory of target computer system and the memory to be emulated. However, such buffers do not provide a solution to the aforementioned problems. Therefore, it is desirable to provide an improved memory emulator which is free from the limitations of the memory capacity and the specification of memory device to be emulated, so as to mitigate and/or obviate the aforementioned problems.

### SUMMARY OF THE INVENTION

An object of the present invention is to provide a memory emulator programmable memory emulator capable of emulating unspecified memory devices.

Another object of the present invention is to provide a development system incorporating a programmable memory emulator in which the memory utilized in the program developing phase is only restricted by the hosts and a trace of memory access can be provided.

Still another object of the present invention is to provide a system chip developing architecture having an excellent system chip debugging and development capability, so that the prototype of system can be developed and the verification of algorithms can executed completely in the system chip developing process without being limited by the specification of the physical memory device.

In accordance with one aspect of the present invention, there is provided a programmable memory emulator for emulating a memory device, which comprises: a host interface for connecting to a host; an emulation look-ahead memory for storing contents of recently accessed memory locations; and an emulation look-ahead memory controller for controlling the emulation look-ahead memory, and connecting to the host via the host interface to control memory of the host, thereby performing memory emulation; wherein, if an input address conforms to the emulation look-ahead memory, the emulation look-ahead memory controller directly access corresponding data from the emulation look-ahead memory; otherwise, the emulation look-ahead memory controller access corresponding data from the host via the host interface, and selectively updates the emulation look-ahead memory.

In accordance with another aspect of the present invention, there is provided a development system using a programmable memory emulator, which comprises: a target system having a memory device to be emulated; a host for providing a memory; and a memory emulator. The memory emulator comprises: a host interface for connecting to the host; an emulation look-ahead memory for storing contents of recently accessed memory locations; and an emulation look-ahead memory controller for controlling the emulation look-ahead memory, and connecting to the host via the host interface to control the memory of the host, thereby performing memory emulation, wherein, if an address from the target system conforms to the emulation look-ahead memory, the emulation look-ahead memory controller directly access corresponding data from the emulation look-ahead memory; otherwise, the emulation look-ahead memory controller access corresponding data from the host via the host interface, and selectively updates the emulation look-ahead memory.

In accordance with still another aspect of the present invention, there is provided a system chip developing architecture, which comprises: a host for providing a memory; and a system chip unit. The system chip unit comprises: a peripheral device for connecting to the host; an emulation look-ahead memory for storing contents of recently accessed memory locations; and an emulation look-ahead memory controller for controlling the emulation look-ahead memory and connecting to the host via the host interface to control the memory of the host, thereby performing memory emulation; and an embedded memory device in cooperation with the emulation look-ahead memory for performing memory emulation, wherein, if an address from a target system is in a memory of the embedded memory device, the emulation look-ahead memory controller directly access corresponding data from the embedded memory device; otherwise, the emulation look-ahead memory controller access corresponding data from the emulation look-ahead memory if the address conforms to the emulation look-ahead memory, or access corresponding data from the host via the host interface if the address doe not conform to the emulation look-ahead memory, and selectively updates the emulation look-ahead memory.

Other objects, advantages, and novel features of the invention will become more apparent from the detailed description when taken in conjunction with the accompanying drawings.

### BRIEF DESCRIPTION OF THE DRAWINGS

FIG. 1 schematically depicts a development system using a programmable memory emulator according to the invention;

FIG. 2 schematically depicts the smart I/O interface shown in FIG. 1;

FIG. 3 depicts the smart I/O interface programmed for a 4K*8 synchronous memory device;

FIG. 4 is a flow chart illustrating the operation of emulation look-ahead memory controller shown in FIG. 1;

FIG. 5 shows a three-stage pipeline execution sequence of a EM/ELM read hit;

FIG. 6 shows a three-stage pipeline execution sequence of a EM/ELM read miss;

FIG. 7 shows a three-stage pipeline execution sequence of a EM/ELM write hit;

FIG. 8 shows a four-stage pipeline execution sequence of a EM/ELM read operation;

FIG. 9 schematically depicts the structure of a system-on-a-chip using the memory emulator according to the invention; and

FIG. 10 schematically depicts a conventional memory emulator system.

### DETAILED DESCRIPTION OF THE PREFERRED EMBODIMENT

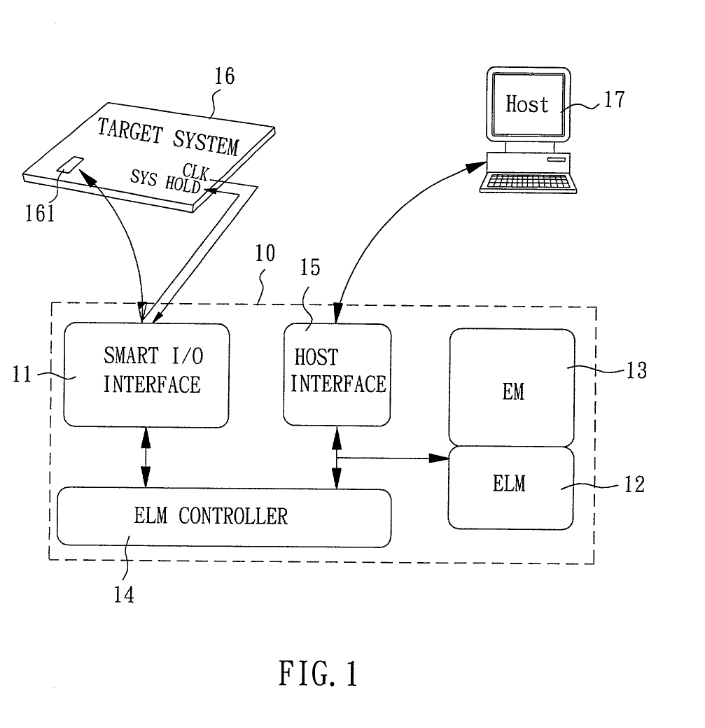

With reference to FIG. 1, there is shown a development system incorporating a programmable memory emulator 10 capable of emulating various kinds of memory device and the memory space is only restricted by the host 17 in accordance with the present invention. As shown, the memory emulator 10 comprises a smart input/output (I/O) interface 11, an emulation look-ahead memory (ELM) 12, an optional emulation memory (EM) 13, an ELM controller 14, and a host interface 15.

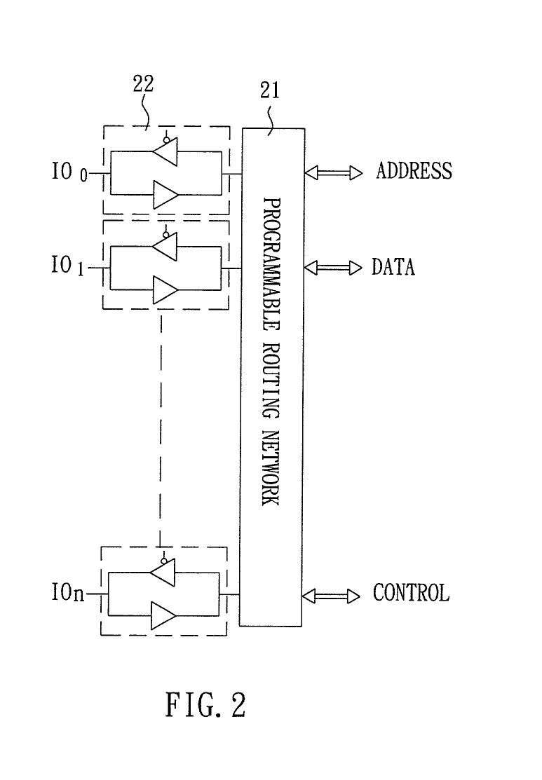

The smart I/O interface 11 is provided to convert signals of the memory device to be emulated into memory access signals capable of being processed by the ELM controller 14. Hence, signals of the memory specifications, including the synchronous/asynchronous interface and parallel/serial interface, can be converted by smart I/O interface 11 into memory access instructions acceptable by the ELM 12. The structure of the smart I/O interface is shown in FIG. 2, which consists of a programmable routing network 21 and a plurality of bi-directional IO ports 22, denoted by IO0 to IOn 22, connected to the programmable routing network 21. The IO signals of the target system 16 are transferred to the programmable routing network 21 through the IO ports 22 corresponding to the memory device 161 to be emulated, such that the IO signals are converted by the programmable routing network 21 into memory address, data, or other control signals as required by ELM controller 14.

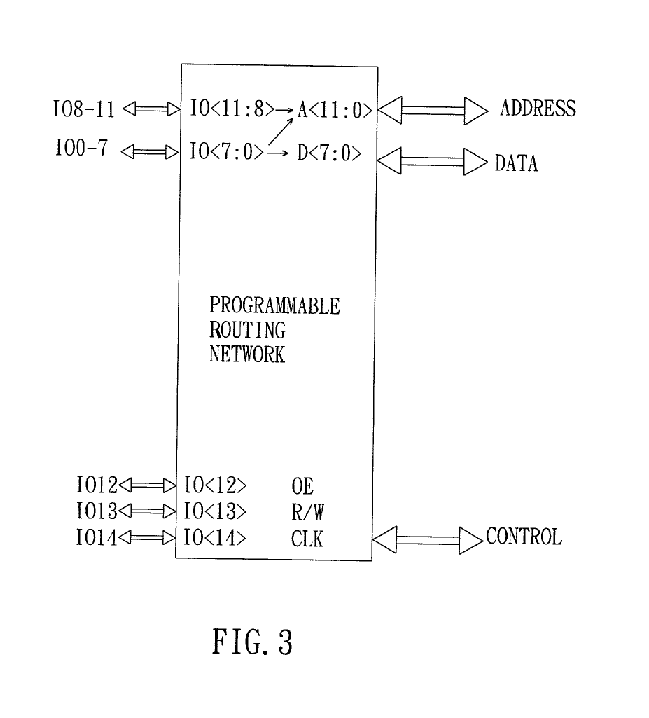

FIG. 3 depicts the smart I/O interface 11 programmed for a 4K*8 synchronous memory device, wherein the IO ports IO0˜IO7 are shared by 8 lines IO<7:0> of the 12 address lines IO<11:0> and data bus D<7:0>. Thus, independent address bus A<11:0> and data bus D<7:0> are created after the conversion of the smart I/O interface 11. Furthermore, the control signals of the IO ports 12˜14 are assigned to be output enable (OE), read/write (R/W), and clock (CLK) signals. In other words, the smart I/O interface 11 is able to convert IO ports of a physical device into the I/O ports of the emulation memory device recognizable by the ELM controller 14. Thus, the programmed IO ports can be employed to replace a conventional adapter, and provide the capability of future memory expansion. By simply increasing the number of the IO ports, the address lines and control signal lines can be increased when memory capacity is expanded.

Referring to FIG. 1 again, the ELM 12 and host 17 are employed to emulate memory device 161 in the target system 16, wherein the content of the recently accessed memory addresses are stored in the ELM 12 which is functioned similar to a cache in a typical computer architecture, known as a layer in the memory hierarchy. In structure, the ELM 12 is divided into tag and data storage areas. The emulator can directly access the corresponding memory content from the ELM 12 if there is a match between the location of memory to be emulated and the tag of EML 12. Otherwise, it means the data to be accessed is not in the ELM 12. Thus, the emulator has to access data from the host 17.

For the purpose of increasing the operation speed, a physical memory device, as that employed in the conventional memory emulator, may be added as the optional EM 13. Thus, the use of EM 13 and ELM 12 together can provide the advantages of memory hierarchical structure. For example, the EM 13 may be employed to store permanent data such as core programs, operating system, etc., while the ELM 12 may be employed to store temporary data such as user data, etc.

Typically, to emulate a memory access operation from the host 17, a complex transmission protocol must be performed, which results in that the access time thereof is longer than that of accessing a physical memory device. Therefore, the use of the ELM 12 can effectively shorten the memory emulation access cycle, so as not to be limited by the capacity of physical memory while maintaining an acceptable performance. The ELM 12 can be programmed by the known memory cache technique to store contents of recently accessed memory location. Also, the change of the memory image of an embedded system is generally smaller than that of a conventional computer system. Hence, it is applicable to load a partial memory image (e.g., program codes or data segments) into the ELM 12 in advance during the initialization of system memory emulation, so as to effectively avoid the bad performance of the conventional cache caused by the cold start.

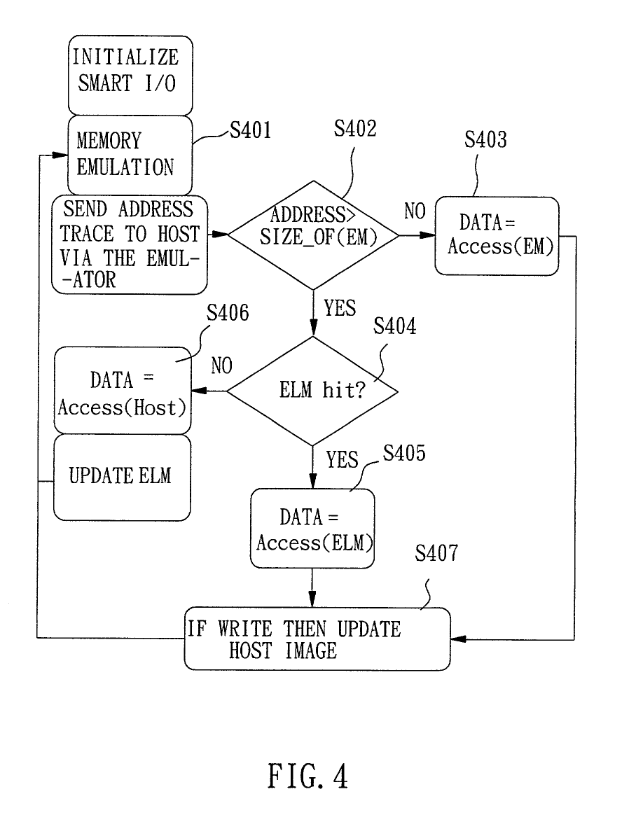

The emulation to the memory device 161 in the target system 16 by using the emulation of ELM 12, EM 13, and host 17 is controlled by the ELM controller 14. The operating flow is illustrated in FIG. 4, which first initializes the smart I/O interface 11 for undergoing a memory emulation (Step S401); i.e., the target system 16 will send address trace to host 17 via the emulator 10. In step S402, the address is compared with the size of the EM 13. If the address is in the range of the EM 13, step S403 is performed to directly access the corresponding data from the EM 13. If the address is out of the range of the EM 13, it indicates that there is no corresponding data in EM 13, and thus step 404 is performed to determine whether there is a match between the location of the memory to be emulated and the tag of ELM 12. If yes, it indicates that there is a successful hit to the ELM 12, and the ELM controller 14 can directly access corresponding data from ELM 12 (step S405). Otherwise, it means that the data to be accessed is not in the ELM 12. The ELM controller 14 will request the correct memory data from the host 17 through the host interface 15 (step S406), and selectively update the ELM 12.

If the access performed in steps S403 and S405 is a write operation, it is required to update the memory image of host 17 (step S407), in addition to writing data into the EM 13 and ELM 12, thereby maintaining a data consistence between the host 17 and the EM 13.

Referring to FIG. 1 again, if the memory emulation can not be completed in a single clock cycle in emulating one of certain memory devices due to the slower operation speed of the memory device to be emulated, the ELM controller 14 will issue a signal to insert the waiting cycles (e.g., to hold the system clock signal CLK, or send out a SYS_HOLD signal indicating that the memory access operation is not completed) through the IO ports 22 of smart I/O interface 11. As a result, a speed match can be achieved.

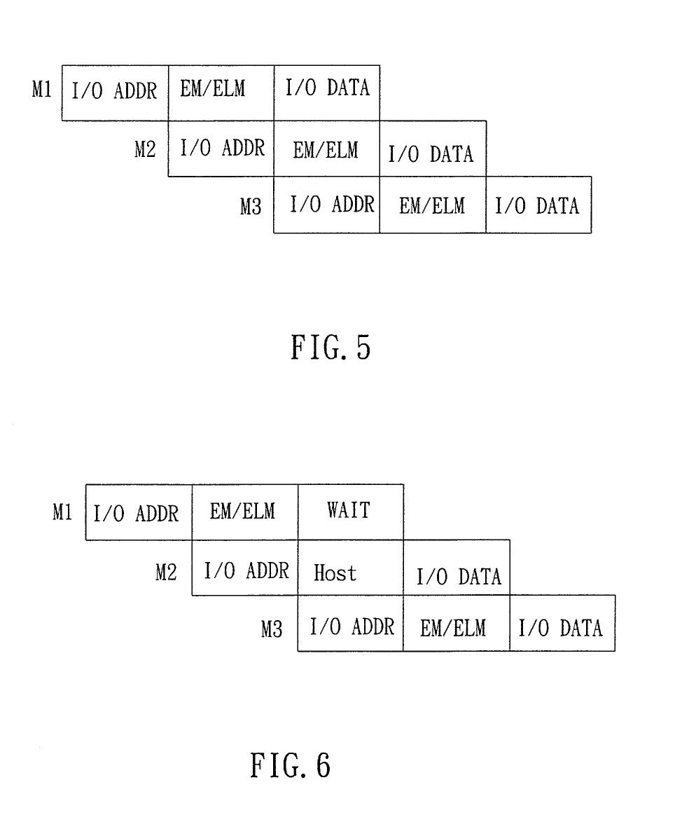

The access operation performed by the memory emulator 10 in accordance with the present invention may be enhanced by a pipeline technique as detailed in FIGS. 5 through 8. For example, if a 3-stage pipeline architecture is employed to implement the memory emulation function, FIG. 5 shows the pipeline execution sequence of a EM/ELM read hit, wherein the memory data to be accessed in emulation is in the EM 13 or ELM 12. As shown, each memory read operation, as denoted by M1, M2, or M3, is completed by three clock cycles. Taking the memory read as an example, in the first cycle, address signals and associated control signals are converted by the smart I/O interface 11 into memory access instructions recognizable by the ELM controller 14. In the second cycle, an access to the EM 13 or ELM 12 is performed. In the third cycle, the corresponding memory data and control signals are sent back to target system 16 through the smart I/O interface 11. If the memory device 161 to be emulated is performed in a pipeline, a memory emulation operation can be completed in each cycle once the pipeline is full. Otherwise, each physical memory access cycle will be divided into three emulation memory access cycles.

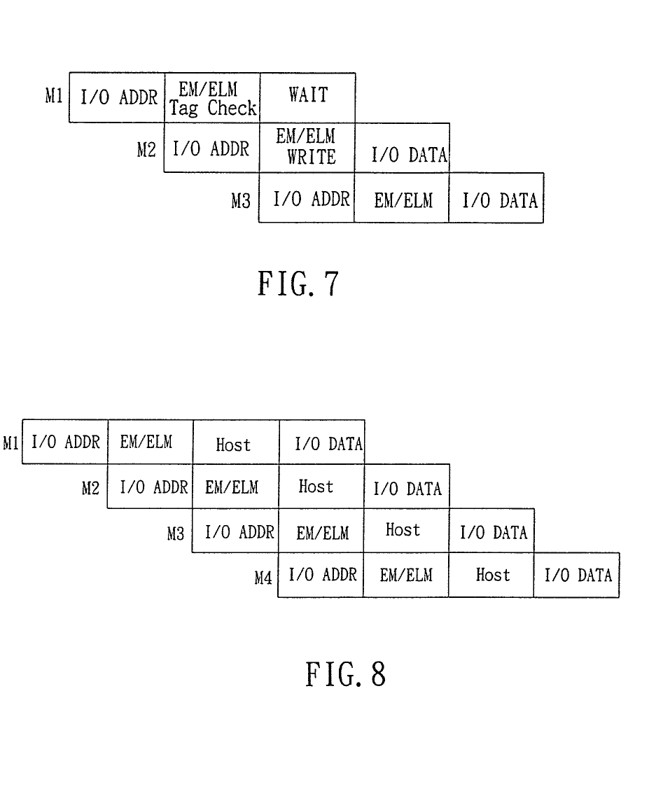

When the memory data to be accessed for emulation is not in EM 13 or ELM 12 of the memory emulator 10, and thus an EM/ELM read miss is occurred, a host access cycle must be inserted, as shown in FIG. 6. Referring to FIG. 7, there is shown an execution sequence for writing EM 13 or ELM 12. To avoid an erroneous write, data written into the ELM 12 is performed only after confirming that there is a match between the location of memory to be emulated and the tag of the EML 12. Thus, an EM/ELM tag check cycle must be inserted in the pipeline execution sequence.

Similarly, the memory emulation function can be implemented with a four or more stage pipeline. With reference to FIG. 8, there is shown a four-stage pipeline execution sequence for read operation. As shown, although the pipeline length is increased, there is no need to add a host access cycle since the time delay caused by EM/ELM read miss has been considered in the pipeline design. The execution sequences for writing and inserting wait states in the EM 13 or ELM 12 are similar to those shown in the three-stage pipeline configuration, so as to be able to shorten the access time of emulating memory.

Referring to FIG. 1 again, data and instruction transmission into or out of the host interface 15 can be achieved in a serial or a parallel manner, and with a dedicated transmission protocol or a standard data transmission protocol. Furthermore, the functionality of host interface 15 can be implemented by utilizing the ELM controller 14 since the ELM controller 14 is built in the memory emulator 10. In addition, the transmission instruction can be initiated either by the host 17 or by the memory emulator 10.

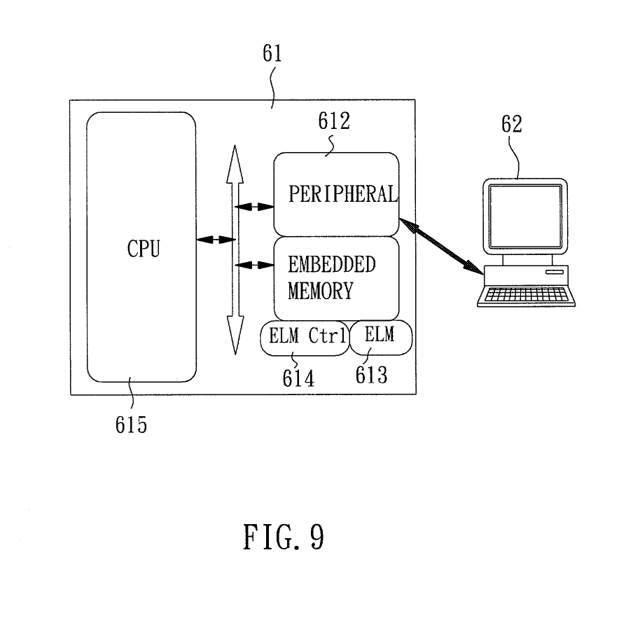

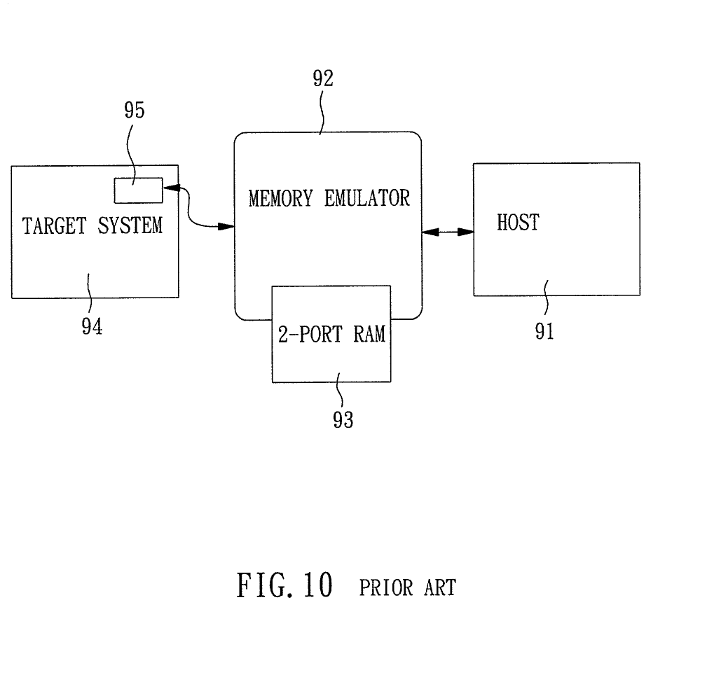

As to the system chip, such as a system-on-a-chip (SOC), the embedded memory device is not required to be limited by the specification of the physical memory device. Thus, the architecture of the memory emulator in accordance with the present invention is able to fully utilize the debugging and development capability of the SOC. Particularly, in the stage of developing embedded single-chip microprocessor, it is able to devote on the development of the system prototype and the verification of algorithms without being limited by the specification of physical memory device. Referring to FIG. 9, there is shown a structure of SOC incorporating the memory emulator according to the present invention. In the SOC 61, the specification of the embedded memory device 611 is determined at the system programming stage. Thus, the aforementioned smart I/O interface 11 in memory emulator 10 may cooperate with the selected embedded memory device 611 for simplifying the circuit. Generally, the programmable routing network 21 is set to be a fixed routing network, so as not to occupy any additional chip area. Moreover, the functionality of EM 13 is provided by embedded memory device 611. Furthermore, the peripheral device 612 on the chip is corresponding to host interface 15. The only modification is the corresponding firmware. The only hardware circuits that are required to be added are the ELM 613 and ELM control 614. When the memory to be accessed by central processing unit (CPU) 615 of the SOC 61 is out of the memory capacity of the embedded memory 611 and data to be accessed is not in the ELM 613, the ELM 613 will transfer the memory access operation to the host 62 through the peripheral device 612. At the same time, ELM 613 is updated in order to increase the speed of subsequent memory emulation operations. With such an architecture, it is possible to emulate the memory device of the SOC 61 by the embedded memory 611, the ELM 613, and the host 62. The emulation operations are the same as that of memory emulator 10, and thus a detailed description is deemed unnecessary.

In view of the forgoing, it is known that the smart I/O interface of the present invention may emulate memory devices having various interface specifications. Furthermore, by employing the ELM to replace the conventional two-port RAM, and utilizing the memory of the host to emulate the functionality of system memory, the memory space available in the program developing stage is not limited by the memory size of memory emulator or SOC. In addition, the ELM controller has to control the memory emulation operation. Hence, it is applicable to provide a trace of memory access in running the system. As a result, information about cost reduction and memory architecture optimization may be obtained by analyzing the trace of memory access.

Although the present invention has been explained in relation to its preferred embodiment, it is to be understood that many other possible modifications and variations can be made without departing from the spirit and scope of the invention as hereinafter claimed.

What is claimed is:

1. A programmable memory emulator for emulating a memory device, comprising:
a host interface for connecting to a host;
an emulation look-ahead memory for storing contents of recently accessed memory locations; and
an emulation look-ahead memory controller for controlling the emulation look-ahead memory, and connecting to the host via the host interface to control memory of the host, thereby performing memory emulation; wherein, if an input address conforms to the emulation look-ahead memory, the emulation look-ahead memory controller directly access corresponding data from the emulation look-ahead memory; otherwise, the emulation look-ahead memory controller access corresponding data from the host via the host interface, and selectively updates the emulation look-ahead memory.

2. The programmable memory emulator as claimed in claim 1, further comprising a smart input/output (I/O) interface for converting signals from the memory device into memory access signals controllable by the emulation look-ahead memory controller.

3. The programmable memory emulator as claimed in claim 2, wherein the smart I/O interface comprises a programmable routing network and a plurality of bi-directional I/O ports connected to the programmable routing network, so that I/O signal are transferred to the programmable routing network via corresponding I/O ports for being converted into memory address, data, or control signals required by the emulation look-ahead memory controller.

4. The programmable memory emulator as claimed in claim 2, further comprising an emulation memory in cooperation with the emulation look-ahead memory to perform memory emulation, wherein, the emulation look-ahead memory controller first compares the input address and the size of the emulation memory, and, when the input address is in the emulation memory, directly access corresponding data from the emulation memory; otherwise, further determines whether the input address conforms to the emulation look-ahead memory.

5. The programmable memory emulator as claimed in claim 4, wherein the emulation look-ahead memory controller performs memory access to the emulation look-ahead memory and the emulation memory through a pipeline.

6. The programmable memory emulator as claimed in claim 4, wherein the emulation look-ahead memory is loaded with a partial memory image before performing memory emulation.

7. A development system using a programmable memory emulator, comprising:
a target system having a memory device to be emulated;
a host for providing a memory; and
a programmable memory emulator, comprising:
a host interface for connecting to the host;
an emulation look-ahead memory for storing contents of recently accessed memory locations; and
an emulation look-ahead memory controller for controlling the emulation look-ahead memory, and connecting to the host via the host interface to control the memory of the host, thereby performing memory emulation; wherein, if an address from the target system conforms to the emulation look-ahead memory, the emulation look-ahead memory controller directly access corresponding data from the emulation look-ahead memory; otherwise, the emulation look-ahead memory controller access corresponding data from the host via the host interface, and selectively updates the emulation look-ahead memory.

8. The development system as claimed in claim 7, wherein the programmable memory emulator further comprises a smart input/output (I/O) interface for converting signals from the memory device into memory access signals controllable by the emulation look-ahead memory controller.

9. The development system as claimed in claim 8, wherein the smart I/O interface comprises a programmable routing network and a plurality of bi-directional I/O ports connected to the programmable routing network, so that I/O signal of the target system are transferred to the programmable routing network via corresponding I/O ports for being converted into memory address, data, or control signals required by the emulation look-ahead memory controller.

10. The development system as claimed in claim 8, wherein the programmable memory emulator further comprises an emulation memory in cooperation with the emulation look-ahead memory to perform memory emulation, and wherein, the emulation look-ahead memory controller first compares the address from the target system and the size of the emulation memory, and, when the address is in the emulation memory, directly access corresponding data from the emulation memory; otherwise, further determines whether the address conforms to the emulation look-ahead memory.

11. The development system as claimed in claim 10, wherein the emulation look-ahead memory controller performs memory access to the emulation look-ahead memory and the emulation memory through a pipeline.

12. The development system as claimed in claim 10, wherein the emulation look-ahead memory is loaded with a partial memory image before performing memory emulation.

13. A system chip developing architecture, comprising:
a host for providing a memory; and
a system chip unit, comprising:
a peripheral device for connecting to the host;
an emulation look-ahead memory for storing contents of recently accessed memory locations; and
an emulation look-ahead memory controller for controlling the emulation look-ahead memory and connecting to the host via the host interface to control the memory of the host, thereby performing memory emulation; and
an embedded memory device in cooperation with the emulation look-ahead memory for performing memory emulation, wherein, if an address from a target system is in a memory of the embedded memory device, the emulation look-ahead memory controller directly access corresponding data from the embedded memory device; otherwise, the emulation look-ahead memory controller access corresponding data from the emulation look-ahead memory if the address conforms to the emulation look-ahead memory, or access corresponding data from the host via the host interface if the address doe not conform to the emulation look-ahead memory, and selectively updates the emulation look-ahead memory.

14. The system chip developing architecture as claimed in claim 13, wherein the emulation look-ahead memory controller performs memory access to the emulation look-ahead memory and the embedded memory device through a pipeline.

15. The system chip developing architecture as claimed in claim 13, wherein the emulation look-ahead memory is loaded with a partial memory image before performing memory emulation.

16. The system chip developing architecture as claimed in claim 13, wherein said system chip unit is a system-on-a-chip.
